(19) United States
(12) Patent Application Publication
(10) Pub. No.: US 2019/0220204 A1
(43) Pub. Date: Jul. 18, 2019

(54) MOBILE LARGE FILE TRANSFER

(71) Applicant: GOVERNMENT OF THE UNITED STATES AS REPRESENTED BY THE SECRETARY OF THE AIR FORCE, Rome, NY (US)

(72) Inventor: MATTHEW PAUL SHAVER, ROME, NY (US)

(21) Appl. No.: 15/961,925

(22) Filed: Apr. 25, 2018

Related U.S. Application Data
(60) Provisional application No. 62/617,748, filed on Jan. 16, 2018.

(51) Int. Cl. G06F 3/06; G06F 17/30; G06F 13/10

(52) U.S. Cl. CPC G06F 3/0613; G06F 17/30126; G06F 3/067; G06F 3/0659; G06F 13/102

(57) ABSTRACT

The invention provides for the transfer of files from one user's media device to another user's media device using a portable communications device such as a smartphone in conjunction with a media adapter. The media adapter provides a plurality of ports for various media devices. The media adapter interfaces with the portable communications device through a plurality of available data ports. A software program or “app” resident in the portable communications device provides control and status of the data transfer through a Graphical User Interface on the portable communications device display.

### PRIORITY CLAIM UNDER 35 U.S.C. § 119(e)

This patent application claims the priority benefit of the filing date of provisional application Ser. No. 62/617,748 having been filed in the United States Patent and Trademark Office on Jan. 16, 2018 and now incorporated by reference herein.

### STATEMENT OF GOVERNMENT INTEREST

The invention described herein may be manufactured and used by or for the Government for governmental purposes without the payment of any royalty thereon.

### TECHNICAL FIELD OF THE INVENTION

This invention relates generally to the field of data storage and transfer. More specifically this invention relates to the transfer of large data files between mobile devices. Still more specifically, this invention relates to the transfer of data from one memory device to another via an intermediary mobile device.

### BACKGROUND OF THE INVENTION

It is appreciated that sharing large data files on the order of 100 megabytes and greater by file transfer is time consuming. While storage devices have become extremely more capable in terms of the amounts of data they can store for a given, and continually shrinking, size, the computing hardware and computational power to transfer data between these modern storage devices remains the barrier to fast file transfer. Moreover, the computing resources required to perform fast file transfer are large and not readily mobile, therefore prohibiting large file transfer in an on-the-go fashion.

Referring to FIG. 1 depicts typical modern data storage devices having a very small form factor in relation to the amounts of data they can actually store, i.e. tens of gigabytes of data.

Referring to FIG. 2 depicts the various types of computers and processors necessary to copy, write, and transfer data between the typical modern data storage devices depicted in FIG. 1. The mobility of a laptop computer is generally the most mobile means presently available for large data file transfers.

To illustrate the respective “large’ file transfer data amounts and the time necessary to transfer such large data files, consider the following:

### Picture Files:

1 JPEG @ 22 mp comprises approximately 5.12 megabytes of data
1 RAW @ 22 mp comprises approximately 26.6 megabytes of data

### Video Files:

720p @ 25 fps H.264: 10 minutes comprises approximately 2.24 gigabytes of data
   60 minutes comprises approximately 13.4 gigabytes of data
1080p @ 25 fps H.264: 10 minutes comprises approximately 5.03 gigabytes of data
   60 minutes comprises approximately 30.2 gigabytes of data

As for the means by which large data files can presently be transferred, we are limited to a few, namely e-mailing, online storage, and transfers from memory cards to computers. In the case of e-mailing files, file size will often determine whether an e-mail will be permitted by the network or Internet Service Provider (ISP) as most have data size limits. Data storage and retrieval speed is limited by bandwidth. Online storage providers typically charge for the service. Lastly memory card data storage requires access to computers to complete the transfer to the destination and as such not conducive to transferring of files between users on-the-go.

### OBJECTS AND SUMMARY OF THE INVENTION

It is therefore a primary object of the present invention to provide a portable means to transfer data files from one user to another user.

It is another object of the present invention to provide a portable means to transfer data files from one user to another user using personal communications devices.

It is yet another object of the present invention to provide an application that resides on a personal communications device to facilitate data file transfer from one user to another user.

It is still another object of the present invention to provide an interface means to a personal communications device to facilitate the transfer of data files from one user's portable file storage media to another user's file storage media

In a preferred embodiment of the present invention, a mobile file transfer device features a media adapter having a first electromechanical interface to a plurality of first data storage media, a second electromechanical interface to a plurality of second data storage media and a third electromechanical interface to a portable communications device, where the personal communications device in cooperation with the media adapter, performs a file transfer.

Still, in the preferred embodiment of the present invention, a mobile file transfer device features a software application having computer executable instructions on a non-transitory storage medium which when executed by the portable communications device causes the portable communications device to operably communicate with the media adapter via the third electromechanical interface so as to facilitate a transfer of data from the first data storage media via the first electromechanical interface to the second data storage media via to the second electromechanical interface.

Further still, the preferred embodiment of the present invention, a mobile file transfer device features software application having computer executable instructions that cause the portable communications device to display an interactive Graphical User Interface for commanding and monitoring the transfer of data.

Briefly stated, the invention provides for the transfer of files from one user's media device to another user's media device using a portable communications device such as a smartphone in conjunction with a media adapter. The media adapter provides a plurality of ports for various media devices. The media adapter interfaces with the portable communications device through a plurality of available data ports. A software program or “app” resident in the portable communications device provides control and status of the data transfer through a Graphical User Interface on the portable communications device display.

### BRIEF DESCRIPTION OF THE DRAWINGS

FIG. 1 is a depiction of several types of memory cards for data file storage and transfer.

FIG. 2 is a depiction of the types of computer devices that memory cards can be read from and written to.

FIG. 3 is a depiction of the present invention and its interfaces to various memory devices and memory cards for data file transfer from one memory device or memory card to another.

FIG. 4 is a depiction of the present invention as it interfaces to a personal communications device such as a smart phone to facilitate data file transfer from one memory device to another memory device.

FIG. 5 is a depiction of the present invention further comprising a smartphone application to facilitate data file transfer from one memory device to another.

### DETAILED DESCRIPTION OF THE PREFERRED EMBODIMENT

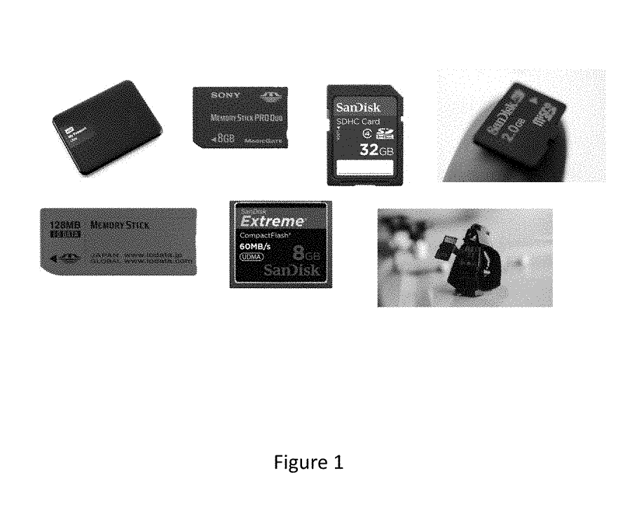

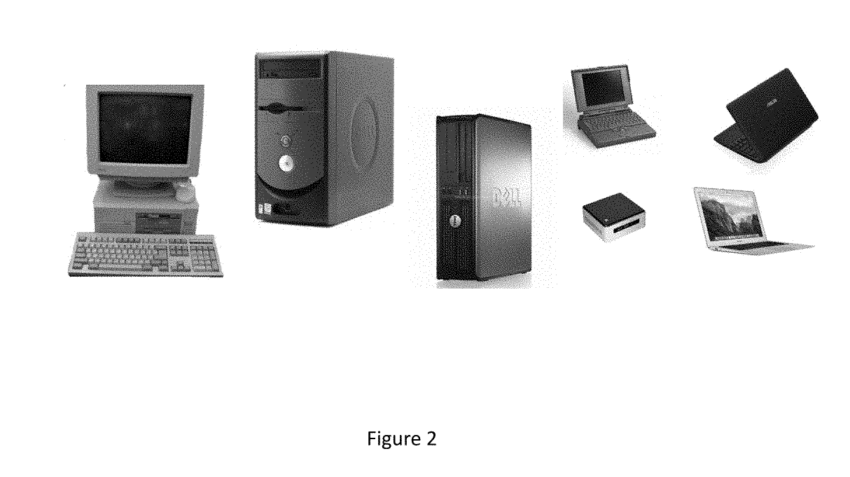

Referring to FIG. 1, depicts several styles of memory cards capable of holding large data files tens of gigabytes each. While memory cards such as those depicted are ideal for transferring data on-the-go, there are presently no mobile devices other than “pseudomobile” laptops and tablet computers capable of performing data file transfer using these memory cards. There may also be memory card size limitations and data file size limitations that can be transferred using tablet computers due to their reduced processing power. In either case, data file transfer from memory cards will require reading and temporarily storing the large data file contents onto the laptop or tablet computer, then transferring the data file to another memory card if the intent is to transfer data files from one user's memory card to another user's memory card. It is important to note that data file transfer between two users' USB memory sticks would be limited to being performed in the same manner. When large data files exceed the ability of “pseudomobile” devices to perform the data transfers, standard, non-mobile or less mobile computer devices (i.e., laptop and desktop computers) such as those depicted in FIG. 2 would be necessary to perform the data transfer. The invention contemplates that there may be data storage devices other than memory cards and USB devices in the future and interoperability with such would be within the scope of the invention as described herein.

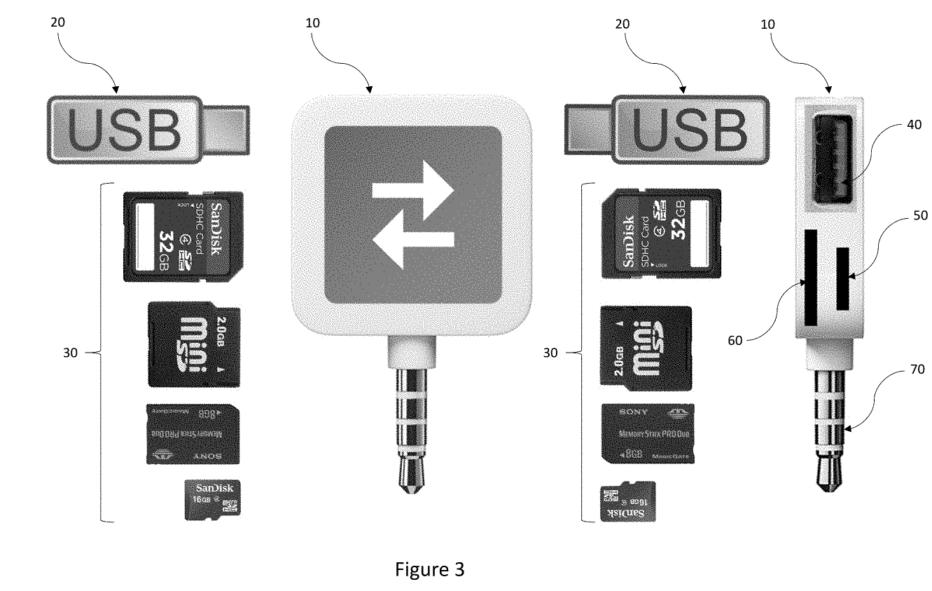

Referring to FIG. 3 depicts the present invention having a media adapter 10 capable of interfacing with a variety of data storage devices inclusive but not limited to USB devices 20 and memory cards 30. The present invention's media adapter 10 has ports 40 for interfacing with USB devices and ports 50 and 60 for interfacing with various size and style memory cards. A duplicate set of electromechanical interfaces or “ports” 40, 50, and 60 are provided by the media adapter 10 so as to facilitate direct transfers of data from one user's USB device 20 or memory card 30 to another user's USB device 20 or memory card 30 with the media adapter 10 facilitating that transfer of data. The media adapter 10 has a plug 70 for communicating with a smartphone or other type of mobile communications or computing device for facilitating the transfer of data. In place of a plug 70, or other connective device such as a cable with USB or micro USB compatibility can be employed as part of the invention to facilitate enhanced data transfer speed and more universal connectivity.

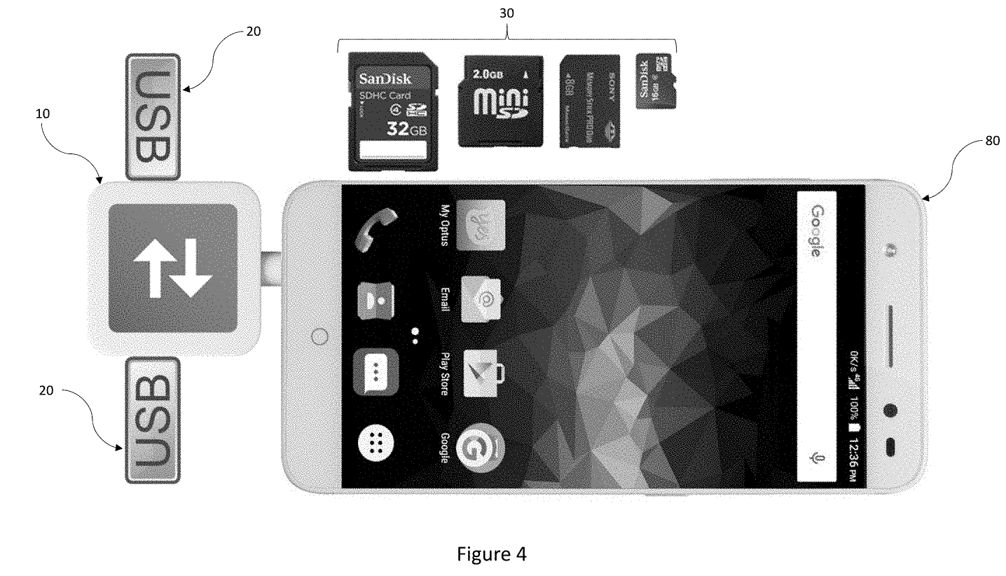

Referring to FIG. 4 depicts the present invention having a media adapter 10 in operable communication with a mobile device 80 to facilitate the transfer of data between two USB memory devices 20, 20. While most mobile devices have a 3 millimeter communication jack for audio signal output the present invention may not be necessarily limited to interfacing with mobile devices at that connection point. Data/charging connection points may also be considered within the scope of the present invention's means for interfacing to mobile devices.

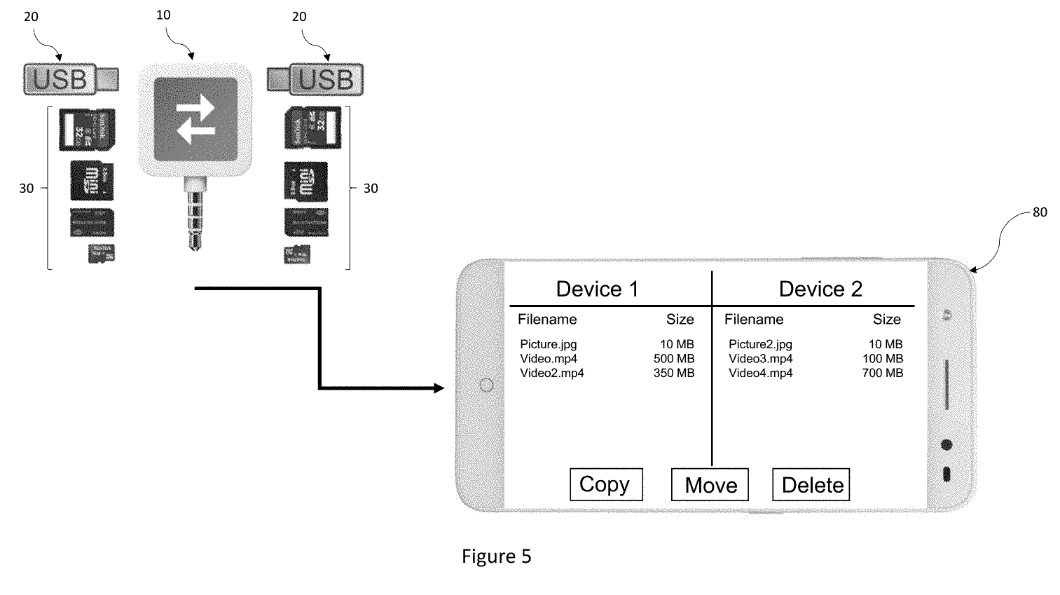

Referring to FIG. 5 depicts that the present invention's scope also includes a software application or “app” that runs on a mobile device to facilitate operable communication between the mobile device 80, the present invention's media adapter 10, and the data storage devices 20, 30 between which data transfer takes place. As depicted, the “app” provides a Graphical User Interface that identifies the status of the files on both data storage devices and may provide for basic commands to copy, move, or delete files. The app may reside as a downloadable software program for execution in the mobile device, or alternatively the app may exist as firmware instructions inside the media adapter 10. It is understood that the app can provide for enhanced functions beyond what is depicted and is only limited by the level of sophistication and extensiveness of the app software itself.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A mobile file transfer device, comprising:
a media adapter, said media adapter having
a first electromechanical interface to a plurality of first data storage media;
a second electromechanical interface to a plurality of second data storage media;
a third electromechanical interface to a portable communications device; and
a software application comprising computer executable instructions on a non-transitory storage medium which when executed by said portable communications device cause said portable communications device to operably communicate with said media adapter via said third electromechanical interface so as to facilitate a transfer of data from said first data storage media via said first electromechanical interface to said second data storage media via said second electromechanical interface.

2. The mobile file transfer device of claim 1, wherein said software application further comprises computer executable instructions that cause said portable communications device to display an interactive Graphical User Interface for commanding and monitoring said transfer of data.

3. The mobile file transfer device of claim 2, wherein said Graphical User Interface provides file name and file size of data files on said first and said second data storage media.

4. The mobile file transfer device of claim 1, wherein said portable communications device is a smartphone.

5. The mobile file transfer device of claim 4, wherein said third electromechanical interface is a plug compatible with an audio jack on said smartphone.

6. The mobile file transfer device of claim 4, wherein said third electromechanical interface is a universal serial bus cable compatible with a data port on said smartphone.

7. The mobile file transfer device of claim 1 wherein said software application comprises a downloadable software app for storage and execution in said portable communication device.

8. The mobile file transfer device of claim 1 wherein said software application comprises firmware instructions contained in said media adapter.

9. A portable system for transferring files, comprising:
a portable communications device; and
a media adapter, wherein said media adapter further comprises
a first electromechanical interface to a plurality of first data storage media;
a second electromechanical interface to a plurality of second data storage media;
a third electromechanical interface to said portable communications device; and wherein said portable communications device further comprises
a software application comprising computer executable instructions on a non-transitory storage medium which when executed by said portable communications device cause said portable communications device to operably communicate with said media adapter via said third electromechanical interface so as to facilitate a transfer of data from said first data storage media via said first electromechanical interface to said second data storage media via said second electromechanical interface.

10. The portable system for transferring files of claim 9, wherein said software application further comprises computer executable instructions that cause said portable communications device to display an interactive Graphical User Interface for commanding and monitoring said transfer of data.

11. The portable system for transferring files of claim 10, wherein said Graphical User Interface provides file name and file size of data files on said first and said second data storage media.

12. The portable system for transferring files of claim 9, wherein said portable communications device is a smartphone.

13. The portable system for transferring files of claim 12, wherein said third electromechanical interface is a plug compatible with an audio jack on said smartphone.

14. The portable system for transferring files of claim 12, wherein said third electromechanical interface is a universal serial bus cable compatible with a data port on said smartphone.

15. The portable system for transferring files of claim 9 wherein said software application comprises a downloadable software app for storage and execution in said portable communication device.

16. The portable system for transferring files of claim 9 wherein said software application comprises firmware instructions contained in said media adapter.
